(19) United States
(12) Patent Application Publication
(10) Pub. No.: US 2021/0323010 A1
(43) Pub. Date: Oct. 21, 2021

(54) FACILITY FOR PRODUCING GLASS WOOL AND SYSTEM FOR SPRAYING PRODUCTS ONTO FIBERS OF SUCH A FACILITY

(71) Applicant: SAINT-GOBAIN ISOVER, COURBEVOIE (FR)

(72) Inventors: Guillaume PAILLARD, CLERMONT (FR); Lionel KIEFER, ARC SUR TILLE (FR)

(21) Appl. No.: 17/267,657

(22) PCT Filed: Jul. 29, 2019
(86) PCT No.: PCT/EP2019/070391

§ 371 Date: Feb. 10, 2021

(30) Foreign Application Priority Data
Aug. 10, 2018 (FR) 1857442

(51) Int. Cl. B05B 7/08; C03C 25/255; C03B 37/022; C03C 25/14; C03C 25/26

(52) U.S. Cl. CPC B05B 7/0892; C03C 25/255; C03C 25/26; C03C 25/14; C03B 37/022

(57) ABSTRACT

A system for spraying products onto glass fibers, designed to spray at least one sizing composition and an anti-dust agent onto the glass fibers includes two separate annular spraying elements which are successively arranged on the path of the glass fibers, the two spraying elements including a first annular element for spraying the sizing composition and a second annular element for spraying the anti-dust agent, each one embodied by at least one specific annular crown surrounding the glass fibers. The second annular element for spraying the anti-dust agent is arranged downstream of the first annular element for spraying the sizing composition in relation to the path of the glass fibers.

The invention relates to the field of producing glass wool, and it more particularly relates to the operations and the corresponding systems for spraying sizing composition and anti-dust agent between and/or onto the glass fibers.

Glass wool production facilities conventionally comprise several successive stations, including a melting station, in which molten glass is generated, a fiberizing station, in which the glass fiber is created, a sizing station, in which the fibers are bonded together by adding a sizing composition, and a crosslinking station, in which the previously obtained mat of fibers bonded to each other is transformed by heating to form the glass wool.

In one particular embodiment of the fiberizing stations, molten glass is deposited in a rotary plate which forms a centrifugation device in the fiberizing station, outside which glass fibers escape which fall in the direction of a conveyor, under the effect of a downward air flow.

The sizing composition is sprayed on the passage of the fibers falling toward this conveyor, participating in forming the binder on the passage of the fibers. In order to prevent the sizing composition from evaporating, it is possible to perform a cooling operation of the fibers to be sized, by spraying a cooling liquid, and in particular water, downstream of the sizing operation. Once cooled, the sized fibers fall onto the conveyor and the mat thus formed is then directed toward an oven forming the crosslinking station, in which the mat is simultaneously dried and subjected to a specific heat treatment which causes polymerization (or “curing”) of the binder resin present on the surface of the fibers.

The continuous mat of glass wool is then intended to be cut in order to form, for example, thermal and/or acoustic insulation panels or rolls.

The spraying of binder is controlled when the fibers to be sized pass through. There is known from the prior art, and in particular from document EP1807259, a binder spraying device comprising two annular crowns carrying spray nozzles and inside which the glass fibers successively pass. A first crown is connected to a binder tank and each spray nozzle associated with this first crown is configured to receive on the one hand a quantity of this binder and on the other hand a quantity of compressed air via an independent feed to spray binder when the glass fibers pass.

It is also known practice to combine the sizing composition with a fatty substance, for example mineral oil, silicone oil or even vegetable oil, emulsified or not, the properties of which make it possible to retain the dust. This is particularly the case when the facility makes it possible to obtain glass wool, which is more particularly intended for household use and for which a product which releases less dust is desired for the end user.

In order to ensure a homogeneous mixture of the oil with the aqueous sizing composition and an applied amount of anti-dust agents which is stable over time, it is known to condition the oil in the form of an oil-in-water emulsion which may or may not be stabilized by surfactants.

Document WO2010/120748 discloses a binder in which the oil is present in emulsion form for its anti-dust properties. This document aims to describe a binder composition comprising a determined percentage of oil in its composition by weight, in order to make it possible to obtain a final fibrous product which is soft to the touch and which does not lose many fibers. The quantity of oil present in the final product is defined, and it is specified that the oil emulsion can be introduced into the network of fibers at the same time as the binder or after the latter, without information being disclosed on the step of applying the oil emulsion in the fiber network.

Document WO2018/042085 discloses a binder in which the oil present in emulsion form is added so as to have a calibrated diameter of oil droplets. This document provides information on the sizing of the droplets and discusses how the sizing composition is mixed with the oil-in-water emulsions forming an anti-dust agent. In this document, the application of the sizing composition to the fibers of the glass wool is carried out by means of a spray crown comprising a plurality of nozzles. According to a first embodiment presented in document WO2018/042085, the oil-in-water emulsion is introduced into the sizing composition by injecting a flow of oil-in-water emulsion into the flow of sizing composition supplying the spray crown. In a second embodiment, the oil-in-water emulsion is added to a tank containing the sizing composition and the obtained mixture is stirred until the oil droplets are homogeneously distributed, upstream of the spray crown.

In each of these documents, the oil is present in or on the torus of glass fibers in the form of oil droplets trapped in water or binder droplets.

However, it is generally assumed that the fraction of oil which is effective to retain dust is that spread on the surface of the layer of binder hardened at the end of the curing step, that is to say on the surface forming an interface between the binder and the air. The oil must therefore separate—during the step of application to the fibers or immediately after—from the other ingredients present in the binder to form a surface layer coating the layer of binder. This is because oil droplets trapped in the cured binder would be ineffective in retaining dust particles.

The present invention falls within this context and aims to provide a method and an associated assembly for spraying a binder composition and an anti-dust agent onto glass fibers which allows an improved reduction of dust, and in particular a faster implementation of anti-dust properties.

Moreover, concerning binders, it is known to use binders based on phenolic compounds, for which the spraying of the binder, the mixing of the binder with the fibers and the passage in an oven of these sized fibers are all easily controlled by industrialists. The phenolic resins which have been used for several decades as binders are increasingly being replaced by products from renewable sources and emitting no, or very little, formaldehyde, also called “Green Binders.” It is thus known, for example from U.S. Pat. No. 8,197,587 and US 2011/0223364, to bind glass fibers with aqueous sizing compositions free of formaldehyde containing carbohydrates and polycarboxylic acids as heat-crosslinkable reagents.

It should be noted that the present invention can fit into the context of using a binder based on biobased products, that is to say a binder without phenolic components, which is therefore more ecological, in order to form a “Green Binder.” While the use of a green binder is less problematic than that of a phenolic binder from an ecological point of view, the inventors have found that the spraying was made more complicated because the components of this green binder generate a binder which is more viscous than the phenolic binder. To do this, it is necessary to add water to the green binder before it is sprayed onto the torus of fibers. This additional water supply can pose a problem of evaporation in the stations following the sizing station.

The present invention also falls within this context and aims to provide a method and an associated assembly for spraying a binder composition and an anti-dust agent onto glass fibers which allows management of the water used in the operations for producing glass wool, and in particular a controlled supply of water upstream of the oven.

The invention relates to a system for spraying products onto glass fibers, designed to spray at least one sizing composition and an anti-dust agent onto the fibers. The spraying system comprises two separate annular spraying elements which are successively arranged on the path of the glass fibers, the two spraying elements comprising a first annular element for spraying the sizing composition and a second annular element for spraying the anti-dust agent, each one embodied by at least one specific annular crown surrounding the glass fibers onto which said products are sprayed, the second annular element for spraying the anti-dust agent being arranged downstream of the first annular element for spraying the sizing composition relative to the path of the glass fibers.

Thus, the system for spraying the products allows independent spraying of the anti-dust agent, which promotes direct distribution of this agent on the outer surface of the glass fibers coated with binder, and which thus allows better action of this agent on dust. In particular, the distinction between the binder and anti-dust spraying steps, and their succession with a spraying of anti-dust agent downstream of the spraying of binder, makes it possible to ensure that the anti-dust agent is positioned on the surface of the sized glass fibers, which constitute the torus of glass fibers which passes opposite the product spraying elements, and this anti-dust agent is not embedded in the thickness of the binder of the sized glass fibers. The effectiveness of this anti-dust agent is thereby improved.

According to one feature of the invention, the anti-dust agent is whole oil. Whole oil refers to an oil which is not diluted and which is not injected into the glass fibers in the form of an emulsion. The presence of two distinct spraying elements in the product spraying system facilitates the spraying of whole oil, the high viscosity of which makes transport and spraying distinctive.

Obviously, the fact that the distribution of the anti-dust agent is carried out separately, distinctly from that of the sizing composition, makes it possible to choose, for example based on the type of sizing composition used, the form in which the anti-dust agent must be brought into its spraying element, and more particularly mineral oil, silicone oil or vegetable oil. In the case of a sizing composition taking the form of a binder based on biobased products which, as was able to be specified previously, involves an increased presence of water to facilitate its distribution in the network of glass fibers, it may thus be preferred to spray a whole oil without emulsion, in order to limit the amount of water which is ultimately present in the glass fiber mat passed in an oven. This limitation on the one hand allows an improvement in the quality of the final product, and on the other hand allows savings in the transport of the oil to the production site, because only the oil therefore needs to be transported, and no longer the oil and water required for the emulsion.

The choice of a whole oil rather than an oil-in-water emulsion also implies that the oil is directly available, without the need for the oil droplet trapped in the water droplet to migrate to the surface in the case of the emulsion. This also implies the absence of surfactants necessary for the emulsion in the sized glass fibers. Other advantages can be noted such as, by way of non-limiting examples, the fact that there is no need for agitation in the oil storage tank when using whole oil, or the fact that bacterial growth in this storage tank is lower with whole oil.

Moreover, the use of a whole oil would allow less sensitivity to temperature variations. Unlike an emulsified oil where breakage of the emulsion can appear, freezing or heating of a whole oil would be less critical because the phenomenon would be reversible by heating the fluid.

It should also be noted that the stability of the liquid is more reliable in the case where a whole oil is used than in the case of an emulsified oil for which it is important to use the oil in the short or medium term under pain of no longer having an emulsified oil available under the prescribed conditions.

According to various features of the invention, taken alone or in combination, it is possible to provide that:
at least the second annular element for spraying the anti-dust agent is configured so that the annular crown comprises two separate distribution circuits, among which a first distribution circuit makes it possible to convey the anti-dust agent and a second distribution circuit makes it possible to convey compressed air; it is understood that according to the invention, a distribution line is specifically dedicated to transporting the anti-dust agent; it is therefore possible to use both specific pumps and temperature control means, the evolution of the distribution temperature of this anti-dust agent, and in particular of the whole oil, making it possible to modify its viscosity and its rate of penetration into the glass fibers;
the first distribution circuit has an average section of diameter smaller than the diameter of the average section of the second distribution circuit;
the second annular element for spraying the anti-dust agent comprises a plurality of spraying members arranged between the two distribution circuits so as to be in fluid communication with each of said distribution circuits;
the spraying members are external mixing nozzles; these nozzles are particularly suitable for spraying an anti-dust agent with a significant viscosity;
the spraying members can be configured to spray a flat jet; it should be noted that the choice of these nozzles makes it possible to generate more homogeneous spraying with the overlap of the jets;
the annular crown forming the second annular element for spraying the anti-dust agent comprises a single feed and a plurality of orifices respectively communicating with a spray member.

According to one feature of the invention, the annular elements for spraying the anti-dust agent and the sizing composition are produced separately by respective annular crowns, the passage section of the annular crown dedicated to spraying the anti-dust agent having a value lower than that of the passage section of the annular crown dedicated to spraying the sizing composition. It is notable according to this feature that the two separate annular spraying elements according to the invention have similar annular shapes facilitating the integration of the spraying device comprising these two annular spraying elements into a facility for producing glass wool. However, while the annular shapes are similar, it should be noted that the dimensions are different in order to adapt one of the spraying elements to the specificities of the anti-dust agent, and in particular of the whole oil when the latter is used. The viscosity of such an oil implies a much lower flow rate than that of the sizing composition, such that it is desirable to reduce the passage section of the spraying element dedicated to spraying oil compared to the spraying element dedicated to spraying sizing composition.

According to features of the invention, provision can be made, by way of nonlimiting examples, for the second annular spraying element to comprise spraying members and for the circulation flow rate of the anti-dust agent to be between 0.1 and 10 kg/h per member, and more particularly between 0.2 and 3 kg/h/member. One particular value of this flow rate can in particular be of the order of 1 kg/h/member.

Furthermore, provision can be made, by way of nonlimiting examples, for the first annular spraying element to comprise spray nozzles and for the circulation flow rate of the sizing composition to be between 10 kg/h and 300 kg/h per nozzle, and more particularly between 50 and 150 kg/h/nozzle. One particular value of this flow rate can in particular be of the order of 50 to 70 kg/h/member.

According to one feature of the invention, the dynamic viscosity of the anti-dust agent suitable for being sprayed onto previously sized fibers, measured here in centiPoise for a given temperature of the anti-dust agent of 20° C., can be between 50 and 3000 cP, and in particular between 200 and 2500 cP. More particularly, such a dynamic viscosity of the oil can be between 300 and 2100 cP, more particularly from 300 to 600 cP at 20° C. Advantage is taken of the fact that the viscosity drops with an increase in temperature. Thus, an oil is advantageously used whose viscosity at 40° C. is less than 200 cP, preferably less than 140 cP at 40° C.

According to one feature of the invention, spraying members and nozzles are distributed regularly over the annular crown dedicated to spraying the anti-dust agent and over the annular crown dedicated to spraying the sizing composition, the spraying members distributed over the annular crown dedicated to spraying the anti-dust agent being fewer in number than the spray nozzles distributed over the annular crown dedicated to spraying the sizing composition.

According to one feature of the invention, there are between five and fifteen spraying members distributed over the annular crown dedicated to spraying the anti-dust agent and there are between five and forty-two spray nozzles distributed over the annular crown dedicated to spraying sizing composition, the number possibly varying in particular depending on the type of spray nozzles used.

By way of example, the number of spraying members provided on the annular crown dedicated to spraying the anti-dust agent may be equal to eight, while the number of spray nozzles provided on the annular crown dedicated to spraying the sizing composition may be equal to seven or nine for a first type of nozzles and equal to sixteen or twenty-four for a second type of nozzles.

The invention also relates to a facility for producing glass wool comprising a system for spraying products onto glass fibers as mentioned above. The facility is configured such that the spraying system is placed on the path of the glass fibers at the outlet of a fiberizing station and upstream of a conveyor configured to bring the glass fibers onto which said products have been sprayed toward an oven.

According to one feature of the invention, in the case where the spraying system is configured to spray whole oil, that is to say non-emulsified oil, the facility can comprise a whole oil tank directly connected to the second annular element for spraying the anti-dust agent. A pump, and where appropriate a device for measuring the temperature of the oil brought into the spraying element, may also be provided.

And the invention further relates to a method for producing glass wool during which a sizing composition, and then whole oil forming anti-dust agent, are successively sprayed at the outlet of a fiberizing station in which molten glass is transformed into glass fibers.

According to one feature of this method according to one aspect of the invention, the spraying of the whole oil is carried out between the spraying of the sizing composition and a step of curing a mat of sized and oiled glass fibers.

Thus, the step of spraying oil forming the anti-dust agent is carried out as close as possible to the step of spraying sizing composition in order to avoid the presence of dust in the sized fibers as quickly as possible. And this oil spraying step is advantageously carried out before the oven in which the sizing composition finishes curing.

Other features, details and advantages of the present invention will emerge more clearly on reading the detailed description given below, by way of indication, in relation to the various embodiments of the invention illustrated in the following figures:

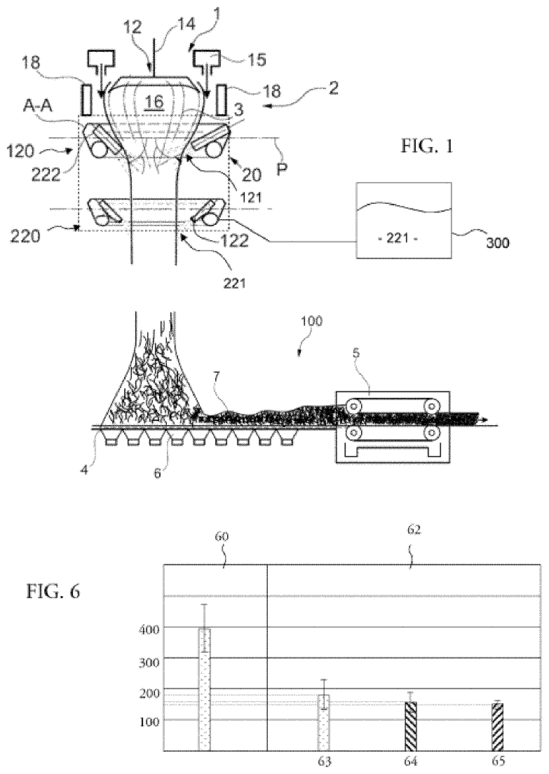

FIG. 1 is a schematic illustration of part of a facility for producing glass wool, in particular illustrating a spraying system according to one aspect of the invention in which a sizing composition and then an anti-dust agent are sprayed on a torus of fibers by means of two successive annular spraying elements;

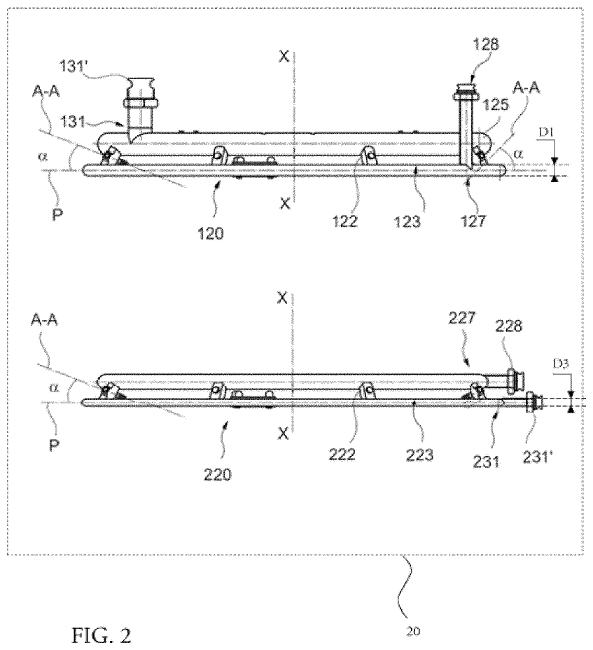

FIG. 2 is a detailed view of the spraying system shown schematically in FIG. 1, in which the two annular spraying elements have been made more visible;

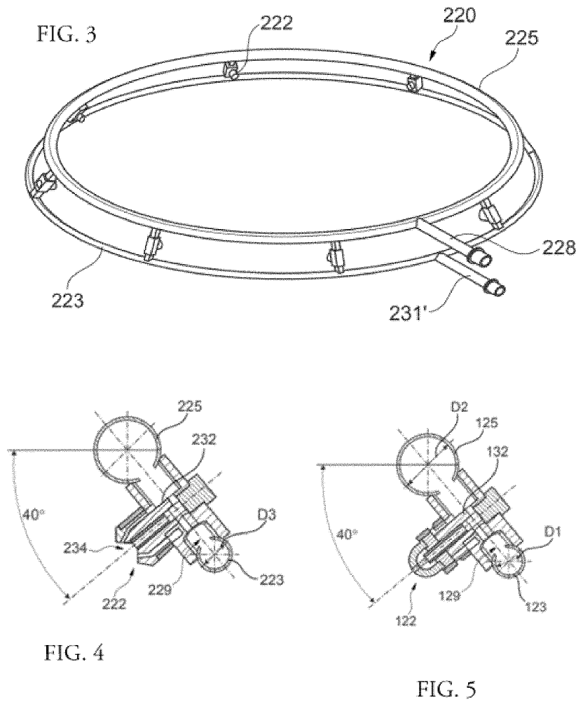

FIG. 3 is a perspective view of the annular spraying member made to spray the anti-dust agent according to one aspect of the invention and forming part of the spraying system of FIG. 2;

FIGS. 4 and 5 are sectional views of a spray nozzle fitted to equip both of the annular spraying elements;

and FIG. 6 is a bar graph illustrating the results of tests for the presence of dust in a volume of fibers passed in a standard spraying system and in a spraying system according to one aspect of the invention.

The invention relates to the implementation of specific devices for the successive spraying of a sizing composition, or binder, and of an anti-dust agent on a torus of glass fibers. As will be described below, the anti-dust agent is sprayed separately from the binder, after the latter, so that it is on the surface of the glass fibers and the effectiveness of its anti-dust functions is immediate.

FIG. 1 illustrates part of a glass wool production facility 100, and more particularly various successive stations participating in creating an insulating blanket made up of sized glass fibers making up an insulating material of the glass wool type.

A first station, called fiberizing station 1, consists in obtaining fibers by means of a centrifugation plate, downstream of which is a second station, called sizing station 2, in which according to the invention on the one hand the sizing of the fibers 3 is carried out which are obtained beforehand by a binder, here a “green binder,” in order to bind them together and on the other hand, the oil is sprayed directly in contact with the glass fibers.

The sized and oiled fibers are placed in a forming station on a conveyor 4, which takes them to an oven forming a crosslinking station 5 and inside which they are heated to crosslink the binder.

The conveyor 4 is permeable to gases and to water, and it extends above suction boxes 6 for gases such as air, fumes and excess aqueous compositions resulting from the fiberizing process described above. A mat 7 of glass wool fibers intimately mixed with the sizing composition is thus formed on the conveyor 4. The mat 7 is led by the conveyor 4 to the oven forming the crosslinking station 5 of the binder.

The fiberizing station 1 here is configured to implement a fiberizing process by internal centrifugation. It will be understood that any type of centrifugation and associated centrifuge can be implemented with the teachings which will follow once fibers are obtained at the outlet of the centrifuge for their subsequent passage through the sizing station.

As an example illustrated in FIG. 1, molten glass can be fed in a stream 14 from a melting furnace and first collected in a centrifuge 12, to then escape through holes drilled in the side wall of the plate in the form of a multitude of filaments driven in rotation. The centrifuge 12 is further surrounded by an annular burner 15 which creates, at the periphery of the wall of the centrifuge, a gas stream at high speed and at a sufficiently high temperature to stretch the glass filaments into fibers in the form of a torus 16.

It will be understood that the example of a fiberizing station given above is indicative and non-limiting of the invention, and that it is also possible to provide a fiberizing method by internal centrifugation with a basket and a perforated bottom wall, or with a plate with a full base, as long as the molten glass is stretched by centrifugation and subsequently spread in the form of a torus of fibers 16 in the sizing station.

Furthermore, other non-limiting variants of the invention can be provided for this fiberizing station, and in particular alternative or cumulative means with respect to the annular burner, and for example heating means 18, for example of the inductor type, used to keep the glass and the centrifuge at the correct temperature.

The torus of fibers 16 thus created at the outlet of the fiberizing station is caused to pass through a spraying system 20 specific to the invention in that it comprises two annular spraying elements 120, 220 which are distinct and arranged successively along the passage of the fiber torus.

A first annular spraying element 120 is configured to surround the torus of fibers and to allow the spraying of a sizing composition 121 formed by way of example by a “green binder,” the first annular spraying element being referred to hereinafter as the sizing device 120, only two spray nozzles 122 of which are shown in FIG. 1.

A second annular spraying element 220 is configured to surround the torus of fibers emerging from the first annular spraying element and to allow the spraying of an oil 221, for example whole oil, the second annular spraying element being referred to as the following oil spraying device 220, only two spraying members 222 of which are shown in FIG. 1.

We will now first describe the first annular spraying element, or sizing device 120, with particular reference to FIG. 2 and to FIG. 5, then secondly the second annular spraying element, or oil spraying device 220, with particular reference to FIG. 2 to 4.

The sizing device 120 comprises an annular crown having a general shape of revolution about an axis of revolution X-X. The crown comprises two separate distribution lines offset along the axis of revolution X-X and a plurality of spray nozzles 122 arranged between these two distribution lines and configured to ensure fluid communication with the distribution lines.

In the illustrated example, the annular crown of the sizing device 120 in particular comprises a first annular tube 123 inside which a first distribution line is provided to allow circulation of the sizing composition, as well as a second annular tube 125, which extends in a plane of revolution, perpendicular to the axis of revolution X-X of the annular crown, and parallel to the plane of revolution of the first annular tube 123. In the following, a plane of revolution P of the annular spraying device is defined as being one or the other of the planes of revolution as they have just been described, or at the very least a plane parallel to them.

Inside this second annular tube 125, a second distribution line is provided to allow circulation of compressed air, capable of spraying the sizing composition 121 onto the fibers passing through the sizing device 120.

The first annular tube 123 has a tubular shape, the internal wall of which, delimiting the first distribution line, has a constant or substantially constant section over the entire periphery of the tube. Substantially constant section refers to a section which remains the same with a separation margin of less than 5%. As an indicative example, the average section of the first annular tube may have a diameter D1 of between 15 mm and 30 mm.

The first annular tube 123 comprises a single feed zone 127 in which is attached a feed pipe 128 for the sizing composition, connected at its other end to a tank of this sizing composition, not shown here.

The sizing composition here consists of a binder with a low formaldehyde content, preferably even without formaldehyde, which will be referred to below as a binder based on biobased products, or “green binder,” it being noted that the viscosity of these biobased products involves the use of large quantities of water to dilute the whole and to form a binder which is capable of being sprayed by the nozzles.

The feed pipe 128, through which “the green binder,” or binder based on biobased products, is brought into the sizing device, here is arranged parallel to the axis of revolution of the annular distribution crown, but it is understood that this feed could be arranged differently without departing from the context of the invention. It should, however, be noted that according to one feature of the invention, the “green binder” is injected into the first distribution line of the first annular tube via a single feed zone, the “green binder” also being intended to circulate all around the first distribution line.

The first annular tube 123 delimiting the first distribution line also comprises a plurality of outlet orifices, regularly distributed over the entire periphery of the first annular tube. As will be described in more detail below, each of these outlet orifices opens out onto a spray nozzle 122 arranged to be in fluid communication with the first distribution line via the corresponding outlet orifice.

It follows from the above that the first annular tube 123 is dedicated to distributing the “green binder” in the direction of the spray nozzles 122.

Furthermore, the second annular tube 125 has a tubular shape, the internal wall of which, delimiting the second distribution line, has a constant or substantially constant section over the entire periphery of the tube. Substantially constant section refers to a section which remains the same with a separation margin of less than 5%. As an indicative example, the average section of the second annular tube may have a diameter D2 of between 30 mm and 50 mm.

In accordance with the first annular tube, the second annular tube 125 comprises a single feed zone 131 in which a feed connector 131′ for a compressed air supply is attached.

The compressed air feed connector 131′ is arranged parallel to the axis of revolution of the annular distribution crown and parallel to the “green binder” feed pipe 128, but it will be understood that this compressed air supply could be arranged differently without departing from the context of the invention. It should, however, be noted that according to one feature of the invention, the compressed air is injected into the second distribution line of the second annular tube via a single feed zone, the compressed air moreover being intended to circulate over the entire perimeter of the second distribution line.

The second annular tube 125 delimiting the second distribution line also comprises a plurality of outlet orifices, regularly distributed over the entire periphery of the second annular tube. In accordance with what has been described for the first annular tube 123, each of these outlet orifices opens out onto a spray nozzle 122 arranged to be in fluid communication with the second distribution line via the corresponding outlet orifice, each of the spray nozzles 122 of the sizing device 120 being in fluid communication on the one hand with the first distribution line and on the other hand with the second distribution line.

It follows from the above that the second annular tube 125 is dedicated to distributing compressed air in the direction of the spray nozzles 122.

This second annular tube 125, delimiting the second distribution line dedicated to the circulation of compressed air, is arranged above the first annular tube 123, delimiting the first distribution line dedicated to the circulation of the sizing composition. For the proper understanding of the above term, reference is made to the position of the sizing device in the facility.

The diameter of the ring formed by the first annular tube is greater than the corresponding diameter of the second annular tube, so that these two annular tubes are arranged one above the other with a radial offset such that the second annular tube is more inside than the first annular tube. This results in an inclined orientation, relative to the axis of revolution of the annular crown, of the spray nozzles 122 which are integral with each of the two annular tubes. Different variant embodiments can be provided in which the spray nozzles are fixed to the annular tubes so that their angle of inclination with respect to the axis of revolution is constant over the entire periphery of the annular spraying device, or so that this angle of inclination varies from one nozzle to another.

The first and second annular tubes are configured so that their internal wall respectively delimiting the first and second distribution lines has a mean section different with respect to each other. In particular, the internal wall of the second tube defines an average section of greater diameter than the diameter of the average section of the internal wall of the second annular tube. The passage section for the “green binder” is therefore smaller than the passage section for the compressed air. Such a feature makes it possible to ensure that the first, narrower distribution line is constantly filled with the binder and that there is no fault in the supply of the spray nozzles. Moreover, giving the first distribution line small dimensions makes it possible to accelerate the movement speed of the “green binder” in this first line and therefore to prevent possible fouling of the first annular tube.

In the same context, note should be made of the distinction to be made between the first annular tube and the second annular tube. As was specified previously, these two annular tubes have a constant mean section. It is understood that the viscous nature of these components presents a risk of seeing them stick to any excessively pronounced roughness inside the annular tube and that the application context of these green binders in the annular spraying device according to the invention involves taking into account this surface roughness and the dimensioning of the annular tube in which the green binder is made to circulate.

The annular tubes 123, 125 are arranged one above the other so that the first outlet orifices of the first distribution line and the second outlet orifices of the second distribution line are axially superimposed, that is to say, they are angularly distributed in the same way about the corresponding axis of revolution of the line.

In this way, the spray nozzle 122 which places a first outlet orifice of the first distribution line in fluid communication with a second outlet orifice of the second distribution line, extends axially, that is to say, in a plane comprising the axis of revolution X-X of the annular crown.

The spray nozzle 122 comprises a body 132 which extends between the two annular tubes, a liquid nozzle which extends across this body 132 along an axis of orientation A-A and at the free end of which a spray head, or air cap, is positioned which is configured to allow the nebulization of the binder based on biobased products, or “green binder,” according to a flat jet.

The set of spray nozzles 122 is arranged so as to have an angle of inclination a between the orientation axis A-A of the liquid nozzle and the plane of revolution P of the annular spraying device equal here to 40°. In general, the spray nozzles can have a common angle of inclination, between 0 and 80°.

The body 132 of each spray nozzle 122 is welded to the annular tubes, once its ends are placed opposite the outlet orifices formed in each of the tubes.

The body 132 comprises, at its center, internal channels configured to separately supply the compressed air and the sizing composition near the spray head, which has a convex shape defining a mixing chamber at the outlet of the liquid nozzle, in which the compressed air and the sizing composition mix to form the drops which are to be sprayed via a spray slot arranged in the spray head.

It is understood that the spray nozzle 122 is configured to allow fluid communication between the first distribution line of the first annular tube 123 and the second distribution line of the second annular tube 125, and that the spray slot, through which the binder based on biobased products exits the annular spraying device, is configured to spray a sizing spray on the torus of fibers and to disperse this spray over a determined angular range.

The operation of the sizing device equipped with at least one spray nozzle as has just been described is as follows. Appropriate control means make it possible to control the arrival of the “green binder” inside the first distribution line via the feed pipe 128. The “green binder” is pushed to circulate over the entire periphery of the annular tube delimiting this first distribution line, and to circulate toward each of the first orifices 129 communicating with the spray nozzle 122. The “green binder” entering the spray nozzle 122 passes inside the liquid nozzle and is pushed toward the spray head and the mixing chamber.

At the same time, appropriate control means make it possible to control the supply of compressed air, at a desired flow rate and pressure, inside the second distribution line via the feed connector 131′. The flow rate and the pressure of the air are in particular determined as a function of the dosage of the sizing composition. The compressed air is pushed to circulate over the entire periphery of the annular tube delimiting this second distribution line, and to circulate toward each of the second orifices communicating with the spray nozzle 122. The compressed air entering the spray nozzle 122 is pushed through circulation pipes on the periphery of the liquid nozzle toward the spray head and the mixing chamber, in which the mixture of the compressed air and the “green binder” participates in the nebulization of the binder, the control of the air flow as a function of the quantity of binder sprayed making it possible in particular to play on the size of the drops.

It will be understood from the above that the spray nozzles 122 associated with the first annular spraying element 120 here have an internal mixing structure, as illustrated by way of example in FIG. 5.

The sizing device comprises a plurality of spray nozzles regularly angularly distributed over the entire periphery of the crown. In particular, the sizing device comprises a series of twenty-four spray nozzles, so that the angular spacing between two successive nozzles of the series is 15° in a plane perpendicular to the axis of the torus of fibers.

As described above and as in particular visible in FIG. 2, the oil distribution device 220 forming the second annular spraying element is arranged downstream of the sizing device 120 relative to the path of the glass fibers.

The oil distribution device 220 will now be described in more detail with particular reference to FIG. 3, initially showing the similarities in design from one annular spraying element to the other.

The oil distribution device 220 comprises an annular crown having a general shape of revolution about an axis of revolution which is parallel and advantageously coincident with the axis of revolution X-X previously described. Two separate distribution circuits offset by a distance d along the axis of revolution X-X are provided, similarly to the distribution lines of the sizing device, and a plurality of spraying members 222 are arranged between these two distribution circuits and configured to ensure fluid communication with the distribution circuits.

In the illustrated example, the annular crown of the oil distribution device in particular comprises a first tubular distribution circuit 223 configured to allow circulation of anti-dust agent, here in the form of whole oil, as well as a second tubular distribution circuit 225, which extends in a plane of revolution parallel to the plane of revolution of the first tubular distribution circuit 223.

The second tubular distribution circuit 225 is configured to allow a circulation of compressed air, capable of spraying the whole oil onto the fibers passing through the spraying system according to one aspect of the invention.

The first tubular distribution circuit 223 has a tubular shape, the internal wall of which has a constant section, or substantially constant over the entire periphery of the tubular circuit. Substantially constant section refers to a section which remains the same with a separation margin of less than 5%. An average section of the first tubular distribution circuit 223 will be given below, with reference to the structural differences existing between the two annular spraying elements.

The first tubular distribution circuit 223 comprises a single feed zone 231 in which a whole oil feed pipe 231′ is attached, connected at its other end to a tank 300 of this whole oil shown schematically in FIG. 1. In the illustrated example, the anti-dust agent is advantageously a whole oil which does not need to be injected in the form of an emulsion, so that the whole oil tank is directly connected to the first tubular distribution circuit 223, a pump being specifically provided between the oil tank and the second annular spraying element 220 to allow the whole oil, which has a high viscosity, to reach this first tubular distribution circuit.

By analogy with what has been described above for the first annular spraying element, the first tubular distribution circuit 223 comprises a plurality of outlet orifices, regularly distributed over the entire periphery of the first tubular distribution circuit, and each of these outlet orifices open out onto a spraying member 222 arranged to be in fluid communication with the first tubular distribution circuit via the corresponding outlet orifice.

It follows from the above that the first tubular distribution circuit 223 is devoted to the distribution of the anti-dust agent, that is to say in this case the whole oil, in the direction of the spraying members 222.

Furthermore, the second tubular distribution circuit 225 has a tubular shape, the internal wall of which has a constant section, or substantially constant over its entire periphery. Substantially constant section refers to a section which remains the same with a separation margin of less than 5%.

In accordance with the first tubular distribution circuit 223, the second tubular distribution circuit 225 comprises a single feed zone 227 in which a feed connector 228 is attached for a compressed air supply. Here again, the compressed air is injected into the second tubular distribution circuit via a single feed zone, the compressed air also being intended to circulate around the entire periphery of the second tubular distribution circuit.

It should be noted here that the pipe and feed connector specific to the second annular spraying element 220 have different orientations, and here perpendicular, to those of the pipe and feed connector specific to the first annular spraying element 120, for space requirement reasons.

By analogy with what has been described above for the first annular spraying element, the second tubular distribution circuit 225 comprises a plurality of outlet orifices, regularly distributed over the entire periphery of the second tubular distribution circuit, each of these outlet orifices opening out onto a spraying member 222 arranged to be in fluid communication with the second tubular distribution circuit 225 via the corresponding outlet orifice.

In this way, each of the spraying members 222 of the oil distribution device 220 is in fluid communication on the one hand with the first tubular distribution circuit 223 and on the other hand with the second tubular distribution circuit 225.

The second tubular distribution circuit 225, dedicated to the circulation of compressed air, is placed above the first tubular distribution circuit 223, dedicated to the circulation of oil. For the correct understanding of the term above, reference is made to the position of the oil distribution device in the facility. The second tubular distribution circuit 225 arranged above the first tubular distribution circuit 223 is arranged as close as possible to the first annular spraying element 120, so that the glass fibers which have just been sized are made to pass first through the second tubular distribution circuit dedicated to compressed air.

By analogy with the above, the diameter of the ring formed by the first tubular distribution circuit is greater than the corresponding diameter of the second tubular distribution circuit, so that these two tubular elements are arranged one above the other with a radial offset so that the second tubular circuit is more inside than the first tubular circuit. This results in an inclined orientation, relative to the axis of revolution of the annular crown, of the spraying members 222. Here again, different variant embodiments can be provided in which the spraying members are fixed to the tubular circuits so that their angle of inclination with respect to the plane of revolution of the annular device is constant over the entire periphery of the annular spraying element, or so that this angle of inclination varies from one member to another. A particular embodiment provides for a constant angle of inclination of about 25°.

The tubular distribution circuits 223, 225 are arranged one above the other so that the first outlet orifices of the first tubular circuit and the second outlet orifices of the second tubular circuit are superimposed axially, that is to say that they are angularly distributed in the same way about the axis of revolution of the second annular spraying element 220.

In this way, the spraying member 222 which places a first outlet orifice of the first tubular circuit in fluid communication with a second outlet orifice of the second tubular circuit extends axially, that is to say in a plane comprising the axis of revolution X-X.

As illustrated in FIG. 4, the spraying member 222 comprises a body 232 which extends between the two tubular circuits and a liquid nozzle which extends across this body along an axis of orientation A-A.

All of the spraying members 222 are arranged so as to have an angle of inclination a between the orientation axis A-A of the liquid nozzle and the plane of revolution P of the annular spraying device here equal to 25°. In general, the spraying members can have an angle of inclination of between 10° and 80°, and more particularly of between 25° and 60°. An even more precise range may be between 25° and 45°, with the preferred value of 25° previously mentioned. It will be understood that the inclination value of the nozzles of each crown must meet a first requirement according to the invention specific to the spraying at each crown and a second requirement specific to the combined spraying of the two crowns. The first requirement is such that on the one hand the binder and the oil must respectively reach the torus of fibers, so that the angle of inclination cannot be close to 90° and such that on the other hand, the binder and the oil must not arrive substantially perpendicular to the direction of flow of the torus of fibers so as not to rebound and return to the spraying members, so that the angle of inclination cannot be close to 0°. The second requirement is such that the angles of inclination of the members and of the spray nozzles must allow the binder to impact the torus of fibers before the oil does. In this way, it is advantageous for the angle of inclination of the spraying members 22 to be at least equal to the angle of inclination of the spray nozzles.

The body 232 of each spraying member 222 is welded to the tubular circuits, once its ends are placed opposite the outlet orifices formed in each of the tubes.

The spraying members 222 differ from the previously described spray nozzles 122 in that they consist of external mixing nozzles. FIG. 4 illustrates such an external mixing nozzle respectively forming the spraying members 222 arranged on the second annular spraying element. Contrary to what may have been described above, the external mixing nozzle does not comprise a mixing chamber formed by an air cap, but a flared ejection zone 234 at the end of the liquid nozzle and onto which the ends of channels carrying compressed air open. Such an external mixing nozzle is particularly advantageous for spraying a product with high viscosity.

The operation of the oil spraying device equipped with at least one spraying member as has just been described is as follows. Appropriate control means make it possible to control the arrival of oil inside the first tubular distribution circuit 223 via the feed pipe 231′. The whole oil is pushed to circulate around the entire periphery of the tubular circuit, and to circulate toward each of the first orifices communicating with the spraying member 222. The whole oil entering the spraying member 222 passes inside the liquid nozzle and is pushed toward the flared ejection zone 234.

Simultaneously, appropriate control means make it possible to control the supply of compressed air, at a desired flow rate and pressure, inside the second tubular distribution circuit 225 via the feed connector 228. The air flow rate and pressure are in particular determined as a function of the oil flow rate. Compressed air is pushed to circulate all around the second tubular distribution circuit, and to flow toward each of the second orifices communicating with the spraying member 222. The compressed air entering the spraying member 222 is pushed into circulation pipes at the periphery of the liquid nozzle, so as to disturb the whole oil at the outlet of the flared zone 234.

The oil distribution device also differs from the sizing device in the number of members and spray nozzles angularly regularly distributed. In particular, the oil distribution device may comprise a series of eight spraying members, so that the angular spacing between two successive members of the series is 45° in a plane perpendicular to the axis of the torus of fibers, while it is recalled that the sizing device may comprise a series of twenty-four spray nozzles, so that the angular spacing between two successive nozzles of the series is 15° in a plane perpendicular to the axis of the torus of fibers. It will be understood that, for a homogeneous distribution of the nozzles, respectively of the spraying members, the angular spacing corresponds to the division of 360° by the number of nozzles, respectively of members, to be provided.

By analogy with what has been described above, the first and second tubular distribution circuits are configured so that their internal wall has a different mean section relative to each other. In particular, the internal wall of the second tube defines an average section of greater diameter than the diameter of the average section of the internal wall of the second annular tube. The passage section for the whole oil is therefore smaller than the passage section for the compressed air. Such a feature is made necessary by the viscosity of the whole oil and the resulting low flow rate, in order to ensure that in this first, narrower tubular distribution circuit, the speed of the oil is sufficient so that there is no fault in the feed of the spraying members.

At least the first tubular distribution circuit 223 is subject to a chemical and/or mechanical deburring operation, in order to remove the ridges at the connection of the outlet orifices 229 and the feed pipe on this first tubular distribution circuit 223. The viscous nature of the whole oil and the low flow rate of the circulation involve this regular surface state in order to prevent the oil from stagnating and accumulating inside the line.

In the distribution system according to one aspect of the invention, it is notable that the spraying of oil takes place separately from the spraying of binder and by means of a specific annular crown surrounding the torus of glass fibers and arranged downstream of the annular crown specifically dedicated to the spraying of binder. In this way, the oil sprayed onto the glass fibers is not covered by the binder, which makes its dust-retaining action more effective.

While the same type of annular crown is used for both sizing and oil spraying devices, it should be noted that these annular crowns differ in particular in the dimension of the tubes called on to receive the oil or the binder, in order to adapt these tubes to the viscosity of the fluid circulating within them. They also differ in the design and number of nozzles that these tubes comprise.

As illustrated in particular in FIG. 2, the dimensions of the annular crown dedicated to spraying the anti-dust agent, that is to say the dimensions of the second annular spraying element 220, are smaller than the dimensions of the annular crown dedicated to spraying the sizing composition, that is to say the dimensions of the first annular spraying element 120. In the illustrated example, on the one hand, the average diameter of the second annular spraying element 220, composed of two superimposed tubular distribution circuits, is less than the average diameter of the first annular spraying element 120, composed of two superimposed annular tubes. And on the other hand, the passage section of the tubular distribution circuit through which the oil passes in the second annular spraying element 220 is less than the passage section of the annular tube crossed by the binder in the first annular spraying element 120.

The difference in dimensions mentioned between the annular spraying elements 120, 220 is a characteristic linked to the separation of the spraying of the binder and of the oil according to the invention, these two products having different properties.

The higher viscosity and the reduced flow rate of the oil compared to the viscosity and the flow rate of the binder should in particular be taken into account. By way of example, the flow rate of the oil can be of the order of 1 kg/h for a spraying member, in comparison with a flow rate of the order of 60 kg/h for a spray nozzle in the sizing device.

By way of nonlimiting example, but representative of the difference in dimensions between the annular spraying elements, the average section of the first tubular distribution circuit 223 in the second annular spraying element 220 may consist of a diameter D3 of between 5 mm and 15 mm, whereas as mentioned above, the average section of the first annular tube 123 in the first annular spraying element 120 may consist of a diameter D1 of between 15 mm and 30 mm.

The external mixing nozzles forming the spraying members are configured to generate a flat jet, that is to say, a jet which extends in a main direction, here the first direction. More specifically, the nozzles are configured so that the flat jet has, in the first direction, a determined opening angle which may here be between 40° and 120°. It is advantageous that the first direction is parallel to the planes of revolution of the annular spraying elements, that is to say, the planes in which each of the annular tubes of the device respectively falls, and therefore that this first direction is perpendicular to the direction of movement of the fibers through the spraying system 20. Thus, an oil spray is ensured over a large angular portion of the torus of fibers. By way of example, the spraying members may comprise a head with a slot of rectangular section which extends mainly in a direction parallel to the plane of revolution of the device. In other words, the slot of rectangular section of the at least one spray nozzle is arranged so that the large side of the rectangle forming this slot of rectangular section extends parallel to a plane of revolution of the annular spraying device.

The low flow rate of the whole oil circulating in the dedicated annular spraying element and the configuration of the spraying members to form a flat jet ensure a low penetration force of the oil so that it remains on the surface of the sized glass fibers forming the torus of fibers.

Implementing an oil spraying device independent of the sizing device makes it possible to significantly reduce the dust present in a given volume of glass fibers, and to have an acceptable quantity of dust which is reproducible from one production to another.

The table of results shown in FIG. 6 illustrates this finding in particular, by showing the number of dust particles present in a given unit of mass of glass wool.

The anti-dust efficiency of the oil-in-water emulsions according to the invention is evaluated using an internal device. A 20 cm×30 cm sample of glass wool is fixed in a frame so that at least one of its main faces is free. A perforated plate having dimensions slightly smaller than that of the sample, fixed on an articulated arm, strikes the free face of the sample. An optical device counts the number of particles released. More particularly, the first frame 60, on the left in FIG. 6, represents the number of dust particles for a given unit of mass of a glass wool, in a case of application of oil in the form of an emulsion injected directly into the binder, with a dosage of 0.4% oil relative to the total weight of glass. An average value of 400 particles is reached, with a large standard deviation from one measurement to another of the order of 250 particles.

The second frame 62, on the right, illustrates the number of dust particles measured in an equivalent unit of mass, when the oil is sprayed separately from the binder via the spraying system described above. In this context, the advantage of using the spraying system with whole oil, that is to say not in emulsion form, has also been illustrated. From left to right in this second frame, the number of dust particles is illustrated which is measured in the case where an oil emulsion 63 is used which is equivalent to that used in the prior art of the first frame 60, a first whole oil 64 and a second whole oil 65, it being understood that the dosage of the oil is in all cases similar to that of the prior art, namely 0.4% oil relative to the total weight of glass, here previously, in the fibers.

It is notable that with the same oil emulsion 63, the implementation of separate spraying makes it possible to reduce the number of dust particles to an average value of about 180 particles, with a reduced standard deviation of about 100.

With the first oil 64, the combined advantage of using an instantly available whole oil and implementing separate spraying can reduce the number of dust particles to an average value of about 160 particles, with a reduced standard deviation of about 70.

With the second oil 65, the combined advantage of using an instantly available whole oil and implementing separate spraying can reduce the number of dust particles to an average value of about 150 particles, with a reduced standard deviation of about 20.

An arrangement according to the invention can be implemented in the device described and illustrated above, and can also be implemented, without departing from the context of the invention, in other embodiments of devices. By way of example, provision could be made for the device to comprise nozzles and/or spraying members arranged directly on the tube or the corresponding tubular circuit, the air being supplied independently for each nozzle or member, without it being necessary to provide an air distribution line common to each nozzle or member, and therefore nozzles or spraying members arranged between two circuits or lines as have been described above. Therefore, such a device is in accordance with the invention in that it comprises a whole oil distribution circuit separate from a binder distribution circuit and a plurality of nozzles/spraying members fluidly communicating with the corresponding distribution circuit in order to spray the corresponding product onto the glass fibers intended to pass inside the spraying system.

According to another example, provision may be made for the nozzles/spraying members to be hydraulic nozzles, also known under the name of “air-less” nozzles, that is to say nozzles operating without a supply of compressed air for spraying binder or oil. In this case, provision can be made to keep the structure described above with a second tubular distribution circuit or a second annular tube which only has a structural function, without serving as a circuit for the compressed air.

The close position of the two annular spraying elements can in particular make it possible to pool the compressed air supply, in a variant which is not shown here.

In general, the embodiments which are described above are in no way limiting: it is in particular possible to imagine variants of the invention comprising only a selection of features described below isolated from the other features mentioned in this document, whether this selection of features is sufficient to confer a technical advantage or to differentiate the invention from the state of the prior art.

1. A spraying system for spraying products onto glass fibers configured to spray at least one sizing composition and an anti-dust agent onto the glass fibers, the spraying system comprising two separate annular spraying elements which are successively arranged on a path of the glass fibers, the two separate annular spraying elements comprising a first annular spraying element for spraying the sizing composition and a second annular spraying element for spraying the anti-dust agent, each one embodied by at least one specific annular crown surrounding the glass fibers onto which said products are sprayed, the second annular spraying element for spraying the anti-dust agent being arranged downstream of the first annular spraying element for spraying the sizing composition relative to the path of the glass fibers.

2. The spraying system according to claim 1, wherein a dynamic viscosity of the anti-dust agent suitable for being sprayed onto previously sized fibers is between 50 and 3000 cP at 20° C.

3. The spraying system according to claim 1, wherein the second annular spraying element comprises spraying members and wherein a circulation flow rate of the anti-dust agent is between 0.1 kg/h and 10 kg/h per member.

4. The spraying system according to claim 3, wherein the circulation flow rate of the anti-dust agent is between 0.2 kg/h and 3 kg/h per member.

5. The spraying system according to claim 1, wherein the first annular spraying element comprises spray nozzles and in that the wherein a circulation flow rate of the sizing composition is between 10 kg/h and 300 kg/h per nozzle.

6. The spraying system according to claim 1, wherein the anti-dust agent is whole oil.

7. The spraying system according to claim 6, wherein the second annular spraying element comprises spraying members, wherein a circulation flow rate of the anti-dust agent is between 0.1 kg/h and 10 kg/h per member, and wherein the spraying members are external mixing nozzles.

8. The spraying system according to claim 1, wherein the first and second annular spraying elements for spraying the anti-dust agent and the sizing composition are produced separately by respective annular crowns, a passage section of the annular crown dedicated to spraying the anti-dust agent having a value lower than that of a passage section of the annular crown dedicated to spraying the sizing composition.

9. The spraying system according to claim 8, wherein the second annular spraying element comprises spraying members and spray nozzles are distributed regularly over the annular crown dedicated to spraying the anti-dust agent and over the annular crown dedicated to spraying the sizing composition, the spraying members distributed over the annular crown dedicated to spraying the anti-dust agent being fewer or equal in number than the spray nozzles distributed over the annular crown dedicated to spraying the sizing composition.

10. The spraying system according to claim 9, wherein the spraying members and spray nozzles are distributed regularly over the annular crown dedicated to spraying the anti-dust agent and over the annular crown dedicated to spraying the sizing composition, the spraying members distributed over the annular crown dedicated to spraying the anti-dust agent being between five and fifteen in number and the spray nozzles distributed over the annular crown dedicated to spraying the sizing composition being between five and forty-two in number.

11. A facility for producing glass wool comprising a spraying system for spraying products according to claim 1, wherein the spraying system is arranged on the path of glass fibers at an outlet of a fiberizing station and upstream of a conveyor configured to bring the glass fibers onto which said products have been spraying toward an oven.

12. A method for producing glass wool comprising spraying successively a sizing composition, then whole oil forming an anti-dust agent at an outlet of a fiberizing station in which molten glass is transformed into glass fibers.

13. The method according to claim 12, wherein the spraying of the whole oil is carried out between the spraying of the sizing composition and a step of curing a mat of sized and oiled glass fibers.

14. A glass wool obtained by a production method according to claim 12.
